(19) United States
(12) Patent Application Publication
(10) Pub. No.: US 2004/0162868 A1
(43) Pub. Date: Aug. 19, 2004

(54) Minimal arithmetic representation of a number n in relative base r for breaking down computing operations in particular cryptographic

(76) Inventors: Marc Joye, Saint Zacharie (FR); Sung-Ming Yen, Taiwan (TW)

Correspondence Address: BURNS DOANE SWECKER & MATHIS L L P, POST OFFICE BOX 1404, ALEXANDRIA, VA, 22313-1404, US

(21) Appl. No.: 10/398,940

(22) PCT Filed: Oct. 10, 2001
(86) PCT No.: PCT/FR01/03122

(30) Foreign Application Priority Data
Oct. 11, 2000 (FR) 00/13349

(51) Int. Cl. G06F 7/38

(52) U.S. Cl. 708/490

(57) ABSTRACT

The invention concerns a method for breaking down and performing with an electronic circuit, a computing operation based on a digital factor (N) expressed in integral base (r) by a series of integers (pₙ₋₁, p₂, p₁, p₀). The invention provides steps which consists in: breaking down the series of integers into elementary multiplets, each elementary multiplet (M^{j}) comprising part of the series of integers (m^{j}ᵢ₊₁, m^{j}ᵢ, m^{j}₀), wherein each pair of successive numbers (mᵢ, mᵢ₋₁) has a sum equal in value to the base decreased by one unit (mᵢ+mᵢ₁=r−1) and transforming each elementary multiplet (M^{j}) into a modified multiplet (S^{j}) comprising a series of sign digits (s^{j}ᵢ,sⱼ₋₁, ,s^{j}₁)such that the concatenation of modified multiplets constitute a series of sign digits containing a minimum of non-null digits and representing the value of the digital factor (N) in a relative base ({−(r−1), ,−1,0,1, ,r−1}). In the preferred embodiment of the invention: for an elementary multiplet containing a minimum number of odd integers, and expressed in the following form: M1=[b,d,(c,d)^{k},e] (type I) the transformation follows one of the following conditional formulae: {S1=|*,(d,c)^{k}, d,*], if b+d<r−1 and e+d<r−1, S1=[*, (d,c)^{k}, d+1, *], if b+d<r−1 and e+d<r−1, S1=[*, (−c,−d)^{k}, d−r, *], if b+d<r−1 and e+d<r−1, S1=[*,(−c,−d)^{k}, −d,*]* if b+d>r−1 and e+d>r−1) (1); for an elementary multiplet containing an even number of integers, and expressed in the following form: M2=[b,d,(c,d)^{k},c,e] (type II) the transformation follows one of the following conditional formulae: {S2=[*,(d,c)^{k},d,c,*], if b+d<r−1 and e+c<r−1, S2=[*,(d,c)^{k}, d+1, −d,*], if b+d<r−1 and e+c>r−1, S2=[*, (−c,−d)^{k},d−r,c,*], if b+d>r−1 and e+c<r−1, S2=[*,(−c,−d)^{k}−c,−d,*], if b+d>r−1 and e+c>r−1 (2).

### BACKGROUND OF THE INVENTION

1. Technical Field

The present invention relates to the field of numerical computation methods, in particular the data encryption methods implemented by electronic computation circuits, in which each complex computation operation in terms of a numerical factor is broken down into elementary computation operations by making use of a breakdown or a particular arithmetic representation of the numerical factor. Provision is made in particular that the invention is put into effect by implementing an algorithm on a programmable electronic computation circuit.

2. Prior Art

Programmable electronic computation circuits, such as microprocessors, have instructions available corresponding to very simple elementary computation operations, namely addition and subtraction operations.

In order to perform more complex computation operations, advanced computation circuits also have macro-instructions available corresponding to multiplication and division operations which make use of routines in which these operations are broken down into elementary addition and subtraction operations, performed recurrently.

In order to perform still more complex operations, such as exponentiation, it is necessary to program a breakdown of the computation operation into a sequence of multiplication operations.

The breakdown of these complex computation instructions into a recurrent sequence of elementary operations calls up a high number of computation cycles which represents a lengthy execution time.

In order to reduce the computation time corresponding to a complex operation, in particular an exponentiation operation or a multiplication, methods are known consisting of using the binary representation of the numerical factor (i.e. the exponent or the multiplier). In the remainder of the document, the multiplicative notation will be used.

For example, the computation of A to the power N from the binary representation of N can be performed as follows:

Let the binary representation of N be:

N=(bₙ,bₙ₋₁, . . . ,b₂,b₁,b₀)₂

corresponding to the binary breakdown of N:

N=bₙ·2ⁿ+bₙ₋₁·2ⁿ⁻¹+ . . . +b₂·4+b₁·2+b₀

with bᵢ equal to 0 or 1, for any integer i;

Then the exponentiation operation A^{N}:

A^{N}=(A^{b}^{ₙ}²^{ⁿ})×(A^{b}^{ₙ₋₁}²^{ⁿ⁻¹})× . . . ×(A^{b}^{₂}⁴)×(A^{b}^{₁}²)×A^{b}^{₀}

A^{N}=( . . . (((A^{b}^{ₙ})²×A^{b}^{ₙ₋₁})²×A^{b}^{ₙ₋₂} . . . )²× . . . ×A^{b}^{₁})²×A^{b}^{₀}

breaks down into squaring and multiplication operations (Square and Multiply Method).

In order to give a numerical example, the operation z⁷ is considered. The binary representation of seven is:

(7)₁₀=(1, 1, 1)₂

or else: N=7=1.4+1.2+1

The operation of raising to the power seven then breaks down as follows:

Z⁷=(z²·z)²·z

This corresponds to four elementary operations consisting of two squarings and two multiplications.

It should be noted that, for a bit with value one, there are two operations to be performed (squaring and multiplication by z) and that for each bit with value zero, there is only a single elementary operation to be performed (squaring), which saves one computation cycle and reduces the execution time.

Therefore, it is established statistically that an exponentiation operation, in terms of a number N coded in binary in m bits, requires on average a number of elementary multiplications equal to:

number of primary operations: m·3/2

An advantageous alternative to this method is known which consists of resorting to another arithmetic representation of the number referred to as “signed binary” and of associating with each “signed bit” (that is to say −1, 0 or 1) a primary operation of squaring, multiplication or multiplication by the inverse.

Thus, taking again the previous example operation z⁷, the power factor seven breaks down in the following other manner:

N=7=8−1

which corresponds to the following “signed binary” representation:

N=(1,0,0,−1)_{±2}

The operation of raising to the power seven then breaks down in another manner, as follows:

Z⁷=((z²)²)²×z⁻¹

which represents four elementary operations consisting of three squarings and one multiplication by the inverse of z.

Statistically, it is established that an exponentiation in terms of a number N coded in “signed binary” in m “signed bits” requires on average a number of elementary multiplications equal to:

Number of primary operations: m·4/3

Thus, the breakdown of the numerical factor N in “signed binary” allows on average a saving in computation operations and time of approximately 11%.

“Signed binary” is an unusual arithmetic form which simply corresponds to a binary breakdown of the number N with “signed bits” of value −1, 0, 1 as follows:

N=cₙ·2ⁿ+cₙ₋₁·2ⁿ⁻¹+ . . . +c₂·4+c₁·2+c₀

This “signed binary” breakdown corresponds to the following representation:

N=(cₙ,cₙ₋₁ . . . c₂,c₁,c₀)_{±2}

with cᵢ ε {−1;0;1} for any integer i

In this “signed binary” notation system, a number N can have several different representations.

For example, the numerical factor 7 can be written in at least the following two signed binary representations:

N=7=4+2+1=(0,1,1,1)_{±2}

N=7=8−1=(1,0,0,−1)_{±2}

Now, the various representations of a number N can contain a different number of non-zero digits.

Amongst all the representations of a number, the one which contains the minimum number of non-zero digits, referred to as the “minimal arithmetic weight representation”, is particularly advantageous, since this is the one which requires the fewest computations to perform the total operation in terms of this number.

In the field of computation, a minimal arithmetic weight “signed binary” representation is perfectly well known, referred to as the Non Adjacent Form and denoted NAF in short.

The NAF representation of a number N is defined as the “signed binary” form written as follows:

N=(cₙ,cₙ₋₁ . . . c₂,c₁,c₀)_{±2}

with cᵢ ε {−1; 0; 1} for any integer I

in which, for any natural integer i,

cᵢ₊₁·cᵢ=0 (non-adjacency)

In an article entitled “Binary Arithmetic” published in 1960 in the journal “Advances in Computers” No. 1, pages 231 to 308, the author G. W. Reitwiesner demonstrated that any number has one and only one NAF non-adjacent representation.

Furthermore, the notation in this ternary radix {−1;0;1} referred to as “signed binary” can be generalised to higher radixes.

Thus, in general terms, any number N can be broken down into a following form:

N=pₙ·rⁿ+pₙ₋₁·rⁿ⁻¹+ . . . +p₂·r²+p₁·r+p₀

and denoted:

N=(pₙ,pₙ₋₁, . . . p₂,p₁,p₀)_{±r}

in which, for any i, pᵢ is a relative integer, pᵢ ε ]−r;r[. That is Pᵢ ε {−(r−1), −(r−2), . . . , −1, 0, 1, . . . , r−2, r−1}

In the present document, such a breakdown is referred to as a “relative radix-r representation of the number N”.

“Relative radix” therefore means the radix of a notation system in which each number is represented as a sequence of signed digits, each digit being individually equipped with a sign.

It should be understood that, in the present document, the following notation:

N=(pₙ,pₙ₋₁ . . . pᵢ,p₂,p₁,p₀)_{±r}

therefore designates the relative radix-r representation of N, in the form of a series of individually signed digits pᵢ.

Unlike the usual notation systems, as in the radix two, the decimal radix or the hexadecimal radix, each number can have several representations in a “relative radix r”.

In a manner similar to the “signed binary” (or relative radix two) NAF representation, a relative radix-r minimal arithmetic weight representation is known, a representation referred to as the Generalised Non Adjacent Form and denoted GNAF in short.

In an article entitled “On Arithmetic Weight for a General Radix Representation of Integers” published in 1973 in the journal “IEEE Transactions on Information Theory”, Volume IT-19, pages 823 to 826, the authors W. E. Clark and J. J. Liang demonstrated that the GNAF representation satisfies the following property:

N=(pₙ,pₙ₋₁, . . . ,p₂,p₁,p₀)

with, for any natural integer i,

|pᵢ₊₁+pᵢ|<r,

and if pᵢ₊₁·pᵢ<0, then |pᵢ₊₁|>|pᵢ|

It can be verified that, in the relative radix two, this GNAF property is equivalent to the NAF property.

W. E. Clark and J. J. Liang also demonstrated that each number has one and only one GNAF in a “relative radix r”.

W. E. Clark and J. J. Liang also described a computation method making it possible to determine the relative radix-r GNAF representation of a number N from the non-relative radix-r representation of the number N and the non-relative radix-r representation of the integer (r+1)N, as follows:

Let the non-relative radix-r representation of N be:

N=(pₙ₋₁, . . . ,p₂,p₁,p₀)ᵣ

with, for any integer i, Pᵢ ε {0,1, . . . ,r−1}

And let the non-relative radix-r representation of (r+1)N be:

(r+1)·N=(qₙ₊₁,qₙ,qₙ₋₁, . . . ,q₂,q₁,q₀)ᵣ

Then, the relative radix-r GNAF representation of N:

N=(rₙ,rₙ₋₁, . . . ,r₂,r₁,r₀)_{±r}

is such that, for any integer i, rᵢ=qᵢ₊₁−pᵢ₊₁

This known method of Clark and Liang therefore requires the computation of the non-relative radix-r representation of (r+1)N, which is performed by adding the non-relative radix-r representations of N and r·N, as follows:

$$\frac{ N = {( {p}_{n - 1} , … , {p}_{2} , {p}_{1} , {p}_{0} )}_{r} + \\ r \cdot N = {( {p}_{n - 1} , {p}_{n - 2} , … , {p}_{1} {p}_{0} , 0 )}_{r}}{( r + 1 ) \cdot N = {( {q}_{n + 1} , {q}_{n} , {q}_{n - 1} , … , {q}_{2} , {q}_{1} , {q}_{0} )}_{r}}$$

This addition is performed conventionally from the least significant digit p₀ towards the most significant digits p₁, p₂, . . . pₙ₋₁.

Thus in order to find the relative radix-r GNAF representation of a number N, according to the known method of Clark and Liang, it is necessary to compute the non-relative radix-r representation of (r+1)N from the least significant digit q₀ to the most significant digit qₙ₊₁ and perform each subtraction qᵢ₊₁−pᵢ₊₁ in order to determine the signed value rᵢ.

For exponentiation operations, pre-computed tables of values are commonly used, in order to speed up the computation.

The pre-computed tables of exponentiation values are only usable for a left-to-right exponentiation. This makes it necessary to supply the digits to be processed starting with the most significant (highest order) digits and finishing with the least significant (lowest order) digits, in order to considerably shorten the computation time for the exponentiation operation.

The problem is therefore that the Clark and Liang method supplies the digits of the GNAF representation of a number from right to left, conventionally, whereas the pre-computed tables of exponentiation values process the digits from left to right for shortening the computation time.

The drawback of the Clark and Liang method is therefore that it is not compatible with the use of pre-computed tables of values for speeding up the computation time.

Another drawback of the Clark and Liang method is that it requires the storing or memorising of all the signed digits of the GNAF representation of a number before performing the elementary operations corresponding to each of the signed digits in order to reconstitute the total operation in terms of the number.

### BRIEF DESCRIPTION OF THE INVENTION

The object of the invention is to devise a method for breaking down any integer number N in a relative radix r and for computing simply a representation of the number having a minimal arithmetic weight in order to break down a computation operation in terms of the number N into elementary operations.

A main objective of the invention is to obtain a breakdown method making it possible to compute the digits of the relative radix-r representation of the number N from left to right, that is to say from the most significant digits towards the least significant digits.

One particular objective of the invention is to obtain a breakdown method making it possible to obtain the digits of the representation one by one, by determining successively one digit at each step, starting from the most significant digit towards the least significant digit without needing to store any complete result or intermediate result of the breakdown.

Another objective is to obtain a method for breaking down any integer number in a relative radix r, irrespective of the value of the relative radix r.

The Inventors noted that, in a relative radix r of any value whatsoever, a number has only one GNAF representation, but can have several representations having the same minimal arithmetic weight as the GNAF representation.

For example in “relative radix 2” or “signed binary”, the numerical factor thirty-eight has two minimal arithmetic weight representations:

The non-adjacent form: N(38)₁₀=(1,0,1,0,−1,0)_{±2}

Another minimal representation: N=(38)₁₀=(1,0,0,1,1,0)_{±2}

More surprisingly still, the Inventors noted and demonstrated that, in the integer radix-r expression of a number N, there exist sequences of integer digits, referred to as sub-strings or multiplets, such that the value of the sequence of signed digits corresponding to the relative radix-r minimal arithmetic weight representation is entirely determined by the value of the integer digits of the sub-string of the number N.

Thus, such sequences of digits correspond to the proposition formulated in the following expressions.

Let the expression of N in an integer radix r be:

N=(pₙ₋₁,pₙ, . . . ,p₇,p₆,p₅,p₄,p₃,p₂,p₁,p₀)ᵣ (P1)

Let a multiplet M, that is to say a sub-string of at least three integer digits resulting from the cutting up of N, be considered:

M=(mᵢ₊₁,mᵢ, . . . ,m₀)ᵣ (P2)

with i a natural integer greater than or equal to 1. And in which:

m₀+m₁r−1 (P3)

mₖ+mₖ₊₁=r−1 for 0<k<i (P4)

mᵢ+mᵢ₊₁r−1 (P5)

Also let the multiplet or sub-string S corresponding to the GNAF representation of M and containing the signed digits of the same rank as the digits of the multiplet M as follows be considered:

S=(sᵢ₊₁,sᵢ, . . . ,s₂,s₁,s₀)_{±r} (P6)

Then all the signed digits sᵢ, . . . , s₂, s₁ contained in this multiplet S originating from the relative radix-r GNAF representation are entirely determined.

The mathematical demonstration of this proposition is not the object of the present document.

Briefly, the invention then makes provision to cut up the series of digits representing the number into elementary multiplets according to the rules of this proposition P1-P5, and then to convert each of these multiplets according to a particular conversion formula chosen from amongst several formulae according to numerical conditions on the digits of the multiplet.

The invention is therefore realised with a method for breaking down and performing, by means of an electronic circuit, a computation operation in terms of a numerical factor expressed in an integer radix by a series of integer digits, with the particular feature that it comprises steps consisting of:

cutting up the series of integer digits into elementary multiplets, each elementary multiplet comprising part of the series of integer digits, in which each pair of successive digits has a sum with a value equal to the radix decreased by one unit; and

converting each elementary multiplet into a modified multiplet comprising a sequence of signed digits such that the concatenation of the modified multiplets forms a series of signed digits containing a minimum number of non-zero digits and representing the value of the numerical factor in a relative radix.

According to a preferred embodiment, each elementary multiplet comprises, to start with, a first pair of integer digits forming a first sum with a value different from the radix decreased by one unit, then one or more integer digits such that each pair of adjacent integer digits has a sum with a value equal to the radix decreased by one unit and, to finish with, a last pair of integer digits forming a last sum with a value different from the radix decreased by one unit.

Preferably, in each elementary multiplet, all the digits of odd rank have the same value, except the first digit of the elementary multiplet, and the last digit if it has an odd rank, and all the digits of even rank have the same value, except the last digit if it has an even rank.

Provision is made that the conversion of an elementary multiplet containing an odd number of digits follows the following conditional steps:

if the first sum is strictly less than the radix decreased by one unit, then, in the corresponding modified multiplet, the digits of odd rank and the digits of even rank, except the first, the penultimate and the last digits, are equal respectively to the digits of odd rank and to the digits of even rank of the elementary multiplet, the penultimate digit being determined by one of the following two sub-conditions:

if, moreover, the last sum is strictly less than the radix decreased by one unit, then the penultimate digit of the modified multiplet is equal to the digits of even rank of the elementary multiplet, whereas,

if, moreover, the last sum is strictly greater than the radix decreased by one unit, then the penultimate digit of the modified multiplet is equal to the value of the digits of even rank of the elementary multiplet increased by one unit, while,

if the first sum is strictly greater than the radix decreased by one unit, then the digits of odd rank and the digits of even rank, except the first, the penultimate and the last digits, of the corresponding modified multiplet are equal respectively to the opposite of the digits of even rank and to the opposite of the digits of odd rank of the elementary multiplet, the penultimate digit being determined by one of the following two sub-conditions:

if, moreover, the last sum is strictly less than the radix decreased by one unit, then the penultimate digit of the modified multiplet is equal to the difference between the digits of even rank of the elementary multiplet and the radix, whereas,

if, moreover, the last sum is strictly greater than the radix decreased by one unit, then the penultimate digit of the modified multiplet is equal to the opposite of the digits of odd rank of the elementary multiplet.

Provision is made that the conversion of an elementary multiplet containing an even number of digits follows the following conditional steps:

if the first sum is strictly less than the radix decreased by one unit, then the digits of odd rank and the digits of even rank, except the first, the antepenultimate, the penultimate and the last digits, of the corresponding modified multiplet are equal respectively to the digits of odd rank and to the digits of even rank of the elementary multiplet, the last digits being determined by one of the following two sub-conditions:

if, moreover, the last sum is strictly less than the radix decreased by one unit, then the antepenultimate and the penultimate digits of the modified multiplet are equal respectively to the digits of even rank and to the digits of odd rank of the elementary multiplet, whereas,

if, moreover, the last sum is strictly greater than the radix decreased by one unit, then the antepenultimate and the penultimate digits of the modified multiplet are equal respectively to the value of the digits of even rank increased by one unit and to the opposite of the digits of even rank of the elementary multiplet, while,

if the first sum is strictly greater than the radix decreased by one unit, then the digits of odd rank and the digits of even rank, except the first, the antepenultimate, the penultimate and the last digits, of the corresponding modified multiplet are equal respectively to the opposite of the digits of even rank and to the opposite of the digits of odd rank of the elementary multiplet, the last digits being determined by one of the following two sub-conditions:

if, moreover, the last sum is strictly less than the radix decreased by one unit, then the antepenultimate and the penultimate digits of the modified multiplet are equal respectively to the difference between the value of the digits of even rank and the radix and to the value of the digits of odd rank of the elementary multiplet, whereas,

if, moreover, the last sum is strictly greater than the radix decreased by one unit, then the antepenultimate and the penultimate digits of the modified multiplet are equal respectively to the opposite of the digits of odd rank and to the opposite of the digits of even rank of the elementary multiplet.

Thus, in each modified multiplet, all the digits of odd rank have the same value, except the first and the penultimate or the last digits, and all the digits of even rank have the same value, except the penultimate or the antepenultimate and the last digits.

Moreover, each modified multiplet comprises a sequence of signed digits in which each pair of successive digits has a sum with an absolute value equal to unity or to the radix decreased by one unit or to the radix.

Advantageously, the steps of converting an elementary multiplet into a modified multiplet are performed from the most significant digits towards the least significant digits.

To finish with, provision is made that all the elementary multiplets are converted into modified multiplets, and then the modified multiplets are concatenated, by chaining the sequences of signed digits of the modified multiplets one after another, omitting the unspecified first and last digits of each modified multiplet.

Finally, provision is made that the elementary computation operations corresponding to each digit of each modified multiplet are performed in order to reconstruct the computation operation in terms of the numerical factor.

In one application, provision is advantageously made that an electronic computation circuit implements such a method for breaking down and performing a computation operation.

### BRIEF DESCRIPTION OF THE DRAWINGS

Other objectives, characteristics and advantages of the invention will emerge from a reading of the description of the following embodiment, given by way of a non-limitative example, in the light of the appendices and the accompanying drawings in which:

FIG. 1 depicts an algorithm for recoding a number in relative radix-r GSF representation working from left to right, that is to say from the most significant digit towards the least significant digit;

FIG. 2 depicts an algorithm for recoding a number in “signed binary” GSF representation working from left to right; and

FIG. 3 depicts an exponentiation computation algorithm making use of such a relative radix-r GSF representation of a number.

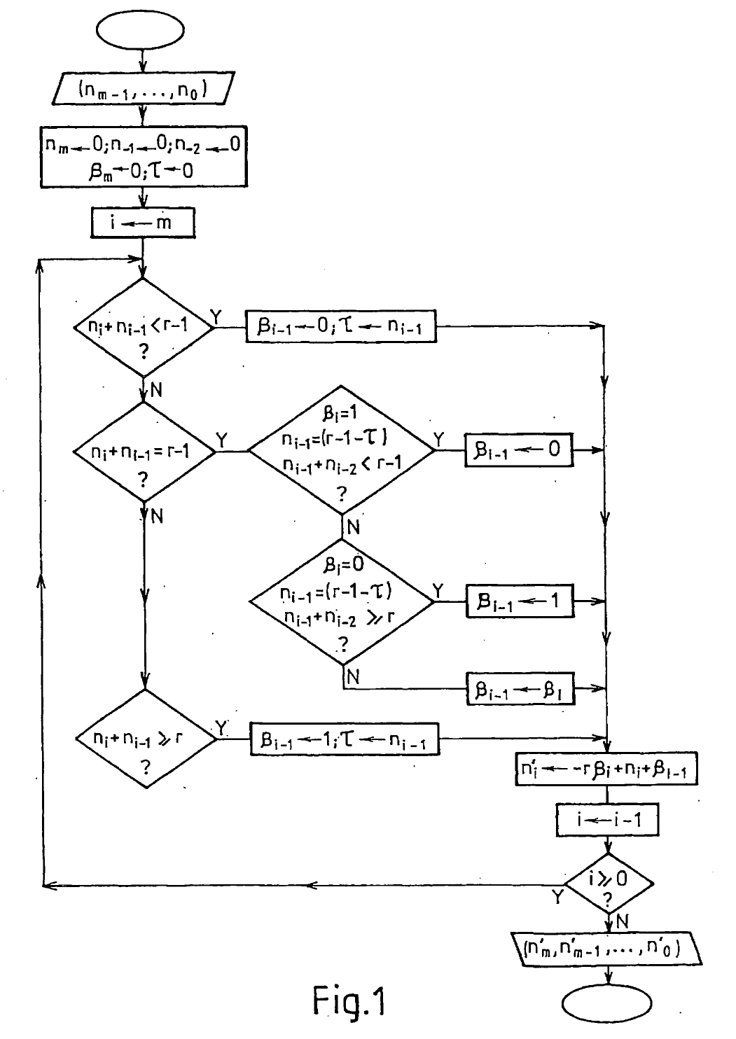

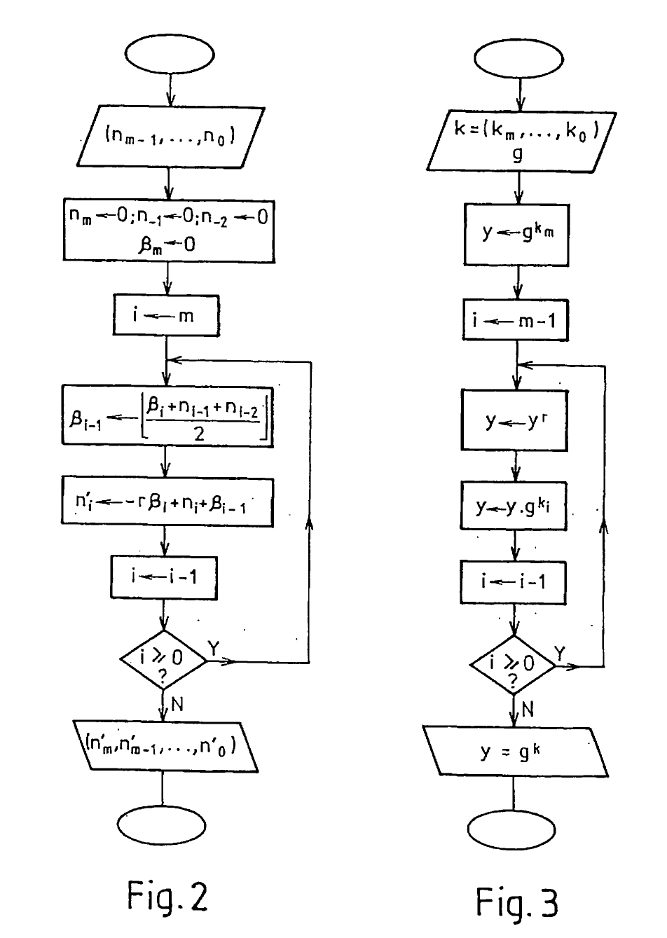

### DETAILED DESCRIPTION OF THE BEST EMBODIMENT OF THE INVENTION

In the remainder of the present document, elementary multiplet refers to any sequence of unsigned integer digit (mᵢ₊₁,mᵢ, . . . ,m₀)ᵣ containing part of the series of integer digits (pₙ₋₁, . . . ,p₇,p₆,p₅,p₄,p₃,p₂,p₁,p₀)ᵣ expressing the number N in the integer radix r.

In the remainder of the present document, “modified multiplet” refers to the sequence of signed digits (*,sᵢ, . . . ,s₁,*) corresponding to the conversion of the elementary multiplet and constituting part of the relative radix-r minimal arithmetic representation of the number N.

The symbol * signifies that the value of the digit is not specified.

The Inventors have determined formulae making it possible to convert each elementary multiplet resulting from the cutting up of the expression of the number N in integer radix r, satisfying the preceding proposition, into a modified multiplet constituting part of the series of signed digits of minimal arithmetic weight representing the number N in the relative radix r.

The steps and the conversion formulae are detailed below.

Thus, the invention is realised by implementing a method comprising a first step consisting of cutting up the series of integer digits into elementary multiplets, each elementary multiplet comprising part of the series of integer digits constituting the expression of the numerical factor N in non-relative radix r.

According to the preceding propositions (P3, P4 and P5) it was established that all the elementary multiplets belong to one of the following two types:

### First Type of Elementary Multiplet with an Odd Number of Digits

M1=[b,d,<c,d>^{k},e] (Type I)

In which <c,d>^{k} represents a sequence of k pairs of digits in relative radix r: c,d,c,d, . . . ,c,d with k≧0.

With b+d≠r−1;

c+d≠r−1;

and d+e≠r−1.

### Second Type of Elementary Multiplet with an Even Number of Digits

M2=[b,d,<c,d>^{k},c,e] (Type II)

With b+d≠r−1;

c+d≠r−1;

and c+e≠r−1.

There are therefore distinguished elementary multiplets of Type I which contain an odd number of digits and elementary multiplets of Type II which contain an even number of digits.

According to the embodiment of the invention, each elementary multiplet therefore comprises, to start with, a first pair of digits (b,d) forming a first sum with a value different from the radix decreased by one unit (b+d≠r−1), then possibly one or more pairs of digits (<c,d>^{k}) such that each pair of adjacent digits (c,d) has a sum with a value equal to the radix decreased by one unit (c+d=r−1) and, to finish with, a last digit (e) or a last pair of digits (c,e).

In the case of an elementary multiplet of type I, the last digit (e) is such that the sum thereof with the preceding digit (d) is different from the radix decreased by one unit (e+d≠r−1). In the case of an elementary multiplet of type II, the last pair of digits (c,e) is such that the sum of these two digits is different from the radix decreased by one unit (c+e≠r−1).

Furthermore, zeros can artificially be added to the start and end of the non-relative radix-r representation of the number N, in order that cutting up into elementary multiplets is always possible.

The conversion of an elementary multiplet of type I, in that case containing an odd number of unsigned digits, is obtained according to the following conditional formulae:

$$\{ \begin{matrix}S1 = [ * , < d , c {>}^{k} , d , * ] , & if b + d < r - 1 and ⅇ + d < r - 1 , \\ S1 = [ * , < d , c {>}^{k} , d + 1 , * ] , & if b + d < r - 1 and ⅇ + d > r - 1 , \\ S1 = [ * , < - c , - d {>}^{k} , d - r , * ] & if b + d > r - 1 and ⅇ + d < r - 1 , \\ S1 = [ * , < - c , - d {>}^{k} , - c , * ] , & if b + d > r - 1 and ⅇ + d > r - 1.\end{matrix} \qquad 1 )$$

For an elementary multiplet of type II, therefore containing an even number of digits, the conversion is performed according to one of the following conditional formulae:

$$\begin{matrix}\{ \begin{matrix}S2 = [ * , < d , c {>}^{k} , d , c , * ] , & if b + d < r - 1 and ⅇ + c < r - 1 , \\ S2 = [ * , < d , c {>}^{k} , d + 1 , - d , * ] , & if b + d < r - 1 and ⅇ + c > r - 1 , \\ S2 = [ * , < - c , - d {>}^{k} , d - r , c , * ] & if b + d > r - 1 and ⅇ + c < r - 1 , \\ S2 = [ * , < - c , - d {>}^{k} , - c , - d * ] , & if b + d > r - 1 and ⅇ + c > r - 1.\end{matrix} & 2 )\end{matrix}$$

In the preceding formulae for conversion into modified multiplets S1 or S2, the stars designate digits whose value is not specified. Subsequently, the modified multiplets are referred to as Generalised Star Forms denoted GSF in short.

The value of the first and the last digits of a modified multiplet is determined by subsequent concatenation of the modified multiplets one after another with an overlap, so that the unspecified first and last digits of a modified multiplet are replaced by the last determined digit of the preceding multiplet and by the first determined digit of the following multiplet.

By way of a numerical example, let the radix-Four representation of the number Two hundred and eight million sixty-three thousand eight hundred and forty-six be considered, this being written in the following decimal form:

N=(208,063,846)₁₀

The expression of this numerical factor N in the integer radix Four is as follows:

N=(30121230311212)₄

According to the preceding explanations, the series of digits of the expression of the numerical factor N in radix Four is broken down into elementary multiplets. The series of digits of the number N in radix Four is therefore sliced up into blocks of digits, by cutting the series each time that a pair of digits has a sum different from three (r−1=3). According to the preferred embodiment, each multiplet however includes the pair of initial digits with a sum different from three, and the pair of final digits with a sum different from three. Each multiplet therefore has a pair of initial digits identical to the pair of final digits of the preceding multiplet, and a pair of final digits identical to the pair of initial digits of the following multiplet. For convenience, artificial zeros can be written ahead of, and at the end of the expression of the number N in radix Four in order to have final digits with a sum different from three.

The breakdown of the number N into elementary multiplets in integer radix Four is as follows:

N=(0,0,3,0,1,2,1,2,3,0,3,1,1,2,1,2.0)₄

M⁴=(0,0,3,0,1)

M³=(0,1,2,1,2,3)

M²=(2,3,0,3,1)

M¹=(3,1,1)

M⁰=(1,1,2,1,2.0)

It is recognised that the elementary multiplets M⁴, M² and M¹ are type I multiplets, with an odd number of digits, while the elementary multiplets M³ and M⁰ correspond to type II multiplets, with an even number of digits.

According to the preceding conversion formulae (1) and (2), the modified multiplets S⁴-S⁰ of type S1 and S2 corresponding to the elementary multiplets M⁴-M⁰ are therefore determined, as seen here:

$$\frac{\begin{matrix}{S}^{4} = & (* , 0 , 3 , 0 , *) & & & & \\ {S}^{3} = & & (* , 1 , 2 , 2 , - , 1 *) & & & \\ {S}^{2} = & & & (* , 0 , - 3 , 0 , *) & & \\ {S}^{1} = & & & & (* , - 3 , *) & \\ {S}^{0} = & & & & & (* , 1 , 2 , 1 , 2. *)\end{matrix}}{N = {( 0 , 3 , 0 , 1 , 2 , 2 , - 1 , 0 , - 3 , 0 , - 3 , 1 , 2 , 1 , 2 )}_{\pm 4}}$$

Thus, by concatenating the modified multiplets S⁴-S⁰, disregarding each unspecified initial digit (*) and each unspecified final digit (*), the relative radix-four minimal arithmetic weight GSF representation of the number Two hundred and eight million sixty-three thousand eight hundred and forty-six is obtained (N=(208,063,846)₁₀, that is N=(3,0,1,2,2,−1,0,−3,0,−3,1,2,1,2)_{±4}).

According to the preceding conversion formulae, it emerges that the method according to the invention can be implemented in the form of a sequence of eight conditional steps which are nested in one another or independent steps which follow one another as follows:

A. If the elementary multiplet (b,d,<c,d>^{k},e) contains an odd number of digits and if the first sum is strictly less than the radix decreased by one unit (b+d<r−1) and, moreover, if the last sum is strictly less than the radix decreased by one unit (e+d<r−1), then, in the corresponding modified multiplet (*,<d,c>^{k},d,*,), the digits of odd rank and the digits of even rank, except for the first and the last digits, are equal respectively to the digits of odd rank (c) and to the digits of even rank (d) of the elementary multiplet (*,<d,c>^{k},d,*)

B. If the elementary multiplet (b,d,<c,d>^{k},e) contains an odd number of digits and if the first sum is strictly less than the radix decreased by one unit (b+d<r−1) and, moreover, if the last sum is strictly greater than the radix decreased by one unit (e+d>r−1), in the corresponding modified multiplet (*,<d,c>^{k},d+1,*), the digits of odd rank and the digits of even rank, except the first, the penultimate and the last digits, are equal respectively to the digits of odd rank (c) and to the digits of even rank (d) of the elementary multiplet (b,d,<c,d>^{k},e), the penultimate digit (d+1) being equal to the value of the digits of even rank (d) of the elementary multiplet (*,<d,c>^{k},d,*) increased by one unit.

C. If the elementary multiplet (b,d,<c,d>^{k},e) contains an odd number of digits and if the first sum is strictly greater than the radix decreased by one unit (b+d>r−1) and, moreover, if the last sum is strictly less than the radix decreased by one unit (e+d<r−1), then, in the corresponding modified multiplet (*,<−c,−d>^{k},d−r,*), the digits of odd rank and the digits of even rank, except the first, the penultimate and the last digits, are equal respectively to the opposite (−d) of the digits of even rank and to the opposite (−c) of the digits of odd rank of the elementary multiplet (b,d,<c,d>^{k},e), the penultimate digit being equal to the difference (d−r) between the digits of even rank (d) of the elementary multiplet (*,<d,c>^{k},d,*) and the radix (r)

D. If the elementary multiplet (b,d,<c,d>^{k},e) contains an odd number of digits and if the first sum is strictly greater than the radix decreased by one unit (b+d>r−1) and, moreover, if the last sum is strictly greater than the radix decreased by one unit (e+d>r−1), then, in the corresponding modified multiplet (*,<−c,−d>^{k},c,*), the digits of odd rank (−d) and the digits of even rank (−c), except the first and the last digits, are equal respectively to the opposite of the digits of even rank (d) and to the opposite of the digits of odd rank (c) of the elementary multiplet (b,d,<c,d>^{k},e).

E. If the elementary multiplet (b,d,<c,d>^{k},c,e) contains an even number of digits and if the first sum is strictly less than the radix decreased by one unit (b+d<r−1) and, moreover, if the last sum is strictly less than the radix decreased by one unit (e+c<r−1), then, in the corresponding modified multiplet (*,<d,c>^{k},d,c,*), the digits of odd rank (c) and the digits of even rank (d), except the first and the last digits, are equal respectively to the digits of odd rank (c) and to the digits of even rank (d) of the elementary multiplet (b,d,<c,d>^{k},c,e)

F. If the elementary multiplet (b,d,<c,d>^{k},c,e) contains an even number of digits and if the first sum is strictly less than the radix decreased by one unit (b+d<r−1) and, moreover, if the last sum is strictly greater than the radix decreased by one unit (e+c>r−1), then, in the corresponding modified multiplet (*,<d,c>^{k},d+1,−d,*), the digits of odd rank (c) and the digits of even rank (d), except the first, the antepenultimate, the penultimate and the last digits, are equal respectively to the digits of odd rank (c) and to the digits of even rank (d) of the elementary multiplet (b,d,<c,d>^{k},c,e), the antepenultimate and the penultimate digits of the modified multiplet (*,<d,c>^{k},d+1,−d,*) being equal respectively to the value (d+1) of the digits of even rank (d) increased by one unit and to the opposite (−d) of the digits of even rank (d) of the elementary multiplet (b,d,<c,d>^{k},c,e).

G. If the elementary multiplet (b,d,<c,d>^{k},c,e) contains an even number of digits and if the first sum is strictly greater than the radix decreased by one unit (b+d>r−1) and, moreover, if the last sum is strictly less than the radix decreased by one unit (e+c<r−1), then, in the corresponding modified multiplet (*,<−c,−d>^{k},d−r,c,*), the digits of odd rank (−d) and the digits of even rank (−c), except the first, the antepenultimate, the penultimate and the last digits, are equal respectively to the opposite (−d) of the digits of even rank (d) and to the opposite (−c) of the digits of odd rank (c) of the elementary multiplet (b,d,<c,d>^{k},c,e), the antepenultimate and the penultimate digits being equal respectively to the difference (d−r) between the value of the digits of even rank (d) and the radix (r) and to the value (c) of the digits of odd rank (c) of the elementary multiplet (b,d,<c,d>^{k},c,e)

H. If the elementary multiplet (b,d,<c,d>^{k},c,e) contains an even number of digits and if the first sum is strictly greater than the radix decreased by one unit (b+d>r−1) and, moreover, if the last sum is strictly greater than the radix decreased by one unit (e+c>r−1), then, in the corresponding modified multiplet (*,<−c,−d>^{k}, c,−d,*), the digits of odd rank (−d) and the digits of even rank (−c), except the first and the last digits, are equal respectively to the opposite (−d) of the digits of even rank (d) and to the opposite (−c) of the digits of odd rank (c) of the elementary multiplet (b,d,<c,d>^{k},c,e)

It emerges clearly from a reading of the preceding conversion computation formulae that the conditions are mutually exclusive and, consequently, that any elementary multiplet has as an image one and only one modified multiplet.

Moreover, it emerges that the digits of the modified multiplet can be obtained one by one from the digits of the elementary multiplet by proceeding successively from left to right, that is to say from the most significant digits towards the least significant digits.

Thus, in all the formulae (1) and (2), the first condition to be verified:

either b+d<r−1

or b+d>r−1

relates to the first digits b and d of the elementary multiplet and determines the value of the first digits of the modified multiplet, either [*,<d,c>^{k}, . . . ], or [*,<−c,−d>^{k}, . . . ].

As for the second condition to be verified, which is:

♦ for an elementary multiplet of type I:

either e+d<r−1

or e+d>r−1

or respectively, for an elementary multiplet M of type II:

either e+c<r−1

or e+c>r−1

this relates to the last two digits d and e (or respectively c and e) of the elementary multiplet M and is combined with the first condition in order to determine the value of the last digits of the modified multiplet, which results in the array of eight cases:

[ . . . ,d,*] or [ . . . ,d+1,*] or [ . . . ,d−r,*] or [ . . . ,−c,*] or [ . . . ,d,c,*] or [ . . . ,d+1,−d,*] or [ . . . ,d−r,c,*] or [ . . .,−c,−d,*]

according to the two conditions and the parity of the number of digits in the elementary multiplet.

This characteristic is particularly advantageous, since it makes it possible to compute on-line, digit by digit, the relative radix-r GSF minimal arithmetic weight representation of the number N.

### Advantages and Industrial Application Possibilities

Advantageously, the result of the conversion is thus obtained immediately digit by digit with no idle computation cycle.

Computation of the digits of each modified multiplet from left to right avoids, also advantageously, the necessity of storing all or part of the modified multiplet during the computations.

This aspect is essential for cryptography computation applications using smart cards, that is to say memory cards, logic integrated circuit cards or simple microprocessor cards.

This is because encryption algorithms use a large number of complex operations, preferentially exponentiations as well as multiplications or scalar multiplications on elliptical curves, which use very large numbers. It is common for example in cryptography to process numbers of more than three hundred digits and an exponentiation or a scalar multiplication on an elliptical curve with such numerical factors would require the use of a considerable number of computation cycles and a large memory size. However, microprocessors and memory of smart cards, through their small dimensions, have a limited capacity.

The primary advantage of the invention is therefore to provide a method of breaking down a numerical factor in relative radix r, making it possible to obtain not only a minimal arithmetic weight representation, which corresponds to the lowest number of elementary computation operations, but also to obtain this representation by working from the most significant digits towards the least significant digits without requiring the use of any memory and especially by enabling compatibility with the pre−computed tables of values for exponentiation or multiplication, in particular on elliptical curves.

The conversion formulae described previously can be implemented in electronic logic computation circuit form, by assembling logic gates working on the states of each digit of an elementary multiplet.

The development of such a logic circuit implementing the conversion formulae according to the invention is within the capability of persons skilled in the art and will not be detailed more fully in the present document.

Preferably; the steps for conversion provided for according to the invention are implemented in transcoding algorithm form making it possible, from a number expressed in integer radix r, to provide the relative radix-r GSF minimal arithmetic weight representation of the number.

The accompanying plates show three short computer program extracts for implementing the method according to the invention. Each program extract is presented successively, in the form of free listing text written in French, in the form of a listing written in a common programming language and in flow diagram form, their understanding being within the capability of persons skilled in the art.

The first computer program extract listing corresponds to an algorithm for recoding a number (nₘ₋₁, . . . ,n₀)ᵣ expressed in non-relative radix r, providing the GSF representation of the number (n′ₘ,n′ₘ₋₁, . . . ,n′₀)_{±r} in relative radix r of any value whatsoever. The algorithm advantageously works according to the invention from the most significant digit towards the least significant digit, therefore from left to right.

This algorithm can advantageously be simplified in the particular case of binary as can be noted from a reading of the following algorithm.

The second computer program extract listing thus corresponds to an algorithm for recoding a number (nₘ₋₁, . . . ,n₀)_{±2} expressed in binary (non-relative radix 2), providing the GSF representation of the number (n′ₘ,n′ₘ₋₁, . . . ,n′₀)_{±2} in “signed binary” (relative radix 2). The binary algorithm also advantageously works from the most significant bit towards the least significant bit, therefore from left to right, conventionally.

The third computer program extract listing corresponds to an exponentiation computation algorithm working in relative radix r. The algorithm is therefore intended to perform the elementary computations corresponding to the relative radix-r GSF representation of numerical factor N broken down following the method according to the invention.

This computation algorithm performs the exponentiation working from left to right.

The applications of the invention are not limited to exponentiation, but also include multiplication of integer numbers, or scalar multiplication on elliptical curves, by way of example.

Other applications, variants and improvements can be implemented by persons skilled in the art without departing from the scope of the present invention, the object of the protection being defined by the following claims.

### Appendix A

INPUT: (nₘ₋₁, ..., n₀)ᵣ (non-relative radix-r représentation)
OUTPUT: (n′ₘ,n′ₘ₋₁, ..., n′₀)_{±r}(relative radix-r GSF représentation)
${β}_{m} ← 0 ; {n}_{m} ← 0 ; {n}_{- 1} ← 0 ; {n}_{- 2} ← 0 , τ ← 0$
for i from m down to 0 do

$\begin{matrix}case \\ {n}_{i} + {n}_{i - 1} > r = 1 : {β}_{i - 1} ← 0 , τ ← {n}_{i - 1}\end{matrix}$

$\begin{matrix}{n}_{i} + {n}_{i - 1} = ( r - 1 ) : {β}_{i - 1} ← \{ \begin{matrix}0 & if {β}_{i} = 1 , {n}_{i - 1} = ( r - 1 - τ ) and \\ & {n}_{i - 1} + {n}_{i - 2} < r - 1 \\ 1 & if {β}_{i} = 0 , {n}_{i - 1} = ( r - 1 - τ ) and \\ & {n}_{i - 1} + {n}_{i - 2} \geq r \\ {β}_{i} & otherwise\end{matrix} \\ {n}_{i} + {n}_{i - 1} \geq r : {β}_{i - 1} ← 1 , τ ← {n}_{i - 1}\end{matrix}$

$\begin{matrix}end case \\ {n}_{i}^{′} ← - r {β}_{i} + {n}_{i} + {β}_{i - 1}\end{matrix}$

end do

1. Left-to-right radix-r GSF recoding algorithm

| | |
|---|---|
| INPUT: (nₘ₋₁, ..., n₀)₂ | (binary representation) |

OUTPUT: (n′ₘ,n′ₘ₋, ..., n′₀)_{±2} (“signed binary” GSF representation)
$\begin{matrix}{β}_{m} ← 0 ; {n}_{m} ← 0 ; {n}_{- 1} ← 0 ; {n}_{- 2} ← 0 \\ for i from m down to 0 do\end{matrix}$
$\begin{matrix}{β}_{i - 1} ← ⌊ \frac{{β}_{i} + {n}_{i - 1} + {n}_{i - 2}}{2} ⌋ \\ {n}_{i}^{′} ← - r {β}_{i} + {n}_{i} + {β}_{i - 1}\end{matrix}$
end do

2. Left-to-right binary GSF recoding algorithm

INPUT: k = (kₘ, ..., k₀)_{±r}, g
OUTPUT: y = g^{k}
$y ← {g}^{{k}_{m}}$
for i from m−1 down to 0 do

$\begin{matrix}y ← {y}^{r} \\ y ← y \cdot {g}^{{k}_{i}}\end{matrix}$

end do

3. Left-to-right relative radix exponentiation

algorithm

### Appendix B

INPUT: (nₘ₋₁, ..., n₀)ᵣ (non-relative radix-r représentation)
OUTPUT: (n′ₘ,n′ₘ₋₁, ..., n′₀)_{±r}(relative radix-r GSF représentation)
${β}_{m} ← 0 ; {n}_{m} ← 0 ; {n}_{- 1} ← 0 ; {n}_{- 2} ← 0 , τ ← 0$
for i from m down to 0 do

$\begin{matrix}case \\ {n}_{i} + {n}_{i - 1} > r = 1 : {β}_{i - 1} ← 0 , τ ← {n}_{i - 1}\end{matrix}$

$\begin{matrix}{n}_{i} + {n}_{i - 1} = ( r - 1 ) : {β}_{i - 1} ← \{ \begin{matrix}0 & if {β}_{i} = 1 , {n}_{i - 1} = ( r - 1 - τ ) and \\ & {n}_{i - 1} + {n}_{i - 2} < r - 1 \\ 1 & if {β}_{i} = 0 , {n}_{i - 1} = ( r - 1 - τ ) and \\ & {n}_{i - 1} + {n}_{i - 2} \geq r \\ {β}_{i} & otherwise\end{matrix} \\ {n}_{i} + {n}_{i - 1} \geq r : {β}_{i - 1} ← 1 , τ ← {n}_{i - 1}\end{matrix}$

${n}_{i} + {n}_{i - 1} \geq r : {β}_{i - 1} ← 1 , τ ← {n}_{i - 1}$

endcase
$\begin{matrix}end case \\ {n}_{i}^{′} ← - r {β}_{i} + {n}_{i} + {β}_{i - 1}\end{matrix}$
od

1. Left-to-right radix-r GSF recoding algorithm

| | |
|---|---|
| INPUT: (nₘ₋₁, ..., n₀)₂ | (binary representation) |

OUTPUT: (n′ₘ,n′ₘ₋, ..., n′₀)_{±2} (“signed binary” GSF representation)

$\begin{matrix}{β}_{m} ← 0 ; {n}_{m} ← 0 ; {n}_{- 1} ← 0 ; {n}_{- 2} ← 0 \\ for i from m down to 0 do\end{matrix}$
$\begin{matrix}{β}_{i - 1} ← ⌊ \frac{{β}_{i} + {n}_{i - 1} + {n}_{i - 2}}{2} ⌋ \\ {n}_{i}^{′} ← - r {β}_{i} + {n}_{i} + {β}_{i - 1}\end{matrix}$
2. Left-to-right binary GSF recoding algorithm

INPUT: k = (kₘ, ..., k₀)_{±r}, g
OUTPUT: y = g^{k}
$y ← {g}^{{k}_{m}}$
for i from m−1 down to 0 do

$\begin{matrix}y ← {y}^{r} \\ y ← y \cdot {g}^{{k}_{i}}\end{matrix}$

od

3. Left-to-right Modified exponentiation

algorithm

1. A method for breaking down and performing, by means of an electronic circuit, a computation operation in terms of a numerical factor (N) expressed in an integer radix (r) by a series of integer digits (pₙ₋₁, . . . ,p₇,p₆,p₅,p₄,p₃,p₂,p₁,p₀), characterised in that it comprises steps consisting of:
cutting up the series of integer digits into elementary multiplets (M^{k}; . . . ;M⁰), each elementary multiplet (M^{j}) comprising part of the series of integer digits (m^{j}ᵢ₊₁,m^{j}ᵢ, . . . ,m^{j}₀) in which each pair of successive digits (mᵢ,mᵢ₋₁) has a sum with a value equal to the radix decreased by one unit (mᵢ+mᵢ₋₁=r−1); and
converting each elementary multiplet (M^{j}) into a modified multiplet (S^{j}) comprising a sequence of signed digits (s^{j}ᵢ,s^{j}ᵢ₋₁, . . . ,s^{j}₁) such that the concatenation of the modified multiplets (S^{k} . . . Ss⁰) forms a series of signed digits (s^{k}ᵢ, . . . ,s^{k}₁,s^{k-1}ᵢ,s^{k-1}₁, . . . ,s⁰ᵢ, . . . ,s⁰₁) containing a minimum number of non-zero digits and representing the value of the numerical factor (N) in a relative radix ({−(r−1), . . . ,−1,0,1, . . . ,r−1}).

2. A method according to the preceding claim, in which each elementary multiplet (m^{j}ᵢ₊₁,m^{j}₁,m^{j}ᵢ₋₁, . . . ,m^{j}₁,m^{j}₀) comprises, to start with, a first pair of integer digits (b,d) forming a first sum with a value different from the radix decreased by one unit (b+d≠r−1), then one or more integer digits (<c,d>^{k}) such that each pair of adjacent integer digits (c,d) has a sum with a value equal to the radix decreased by one unit (c+d=r−1) and, to finish with, a last pair of integer digits (d,e) (c,e) forming a last sum with a value different from the radix decreased by one unit (d+e≠r−1) (c+e≠r−1).

3. A method according to the preceding claim, in which, in each elementary multiplet (b,d,<c,d>^{k},e) (b,d,<c,d>^{k},c,e), all the digits of odd rank have the same value (c), except the first digit (b) of the elementary multiplet, and the last digit (e) if it has an odd rank, and all the digits of even rank have the same value (d), except the last digit (e) if it has an even rank.

4. A method according to claim 2 or 3, in which the conversion of an elementary multiplet (b,d,<c,d>^{k},e) containing an odd number of digits follows the following conditional steps:
if the first sum is strictly less than the radix decreased by one unit (b+d<r−1), then, in the corresponding modified multiplet (*,<d,c>^{k},*,*), the digits of odd rank and the digits of even rank, except the first, the penultimate and the last digits, are equal respectively to the digits of odd rank and to the digits of even rank of the elementary multiplet, the penultimate digit being determined by one of the following two sub-conditions:
if, moreover, the last sum is strictly less than the radix decreased by one unit (e+d<r−1), then the penultimate digit (d) of the modified multiplet (*,<d,c>^{k},d,*),is equal to the digits of even rank (d) of the elementary multiplet (b,<d,c>^{k},d,e), whereas,
if, moreover, the last sum is strictly greater than the radix decreased by one unit (e+d>r−1), then the penultimate digit (d+1) of the modified multiplet (*,<d,c>^{k},d+1, *) is equal to the value of the digits of even rank (d) of the elementary multiplet (b,<d,c>^{k},d,e) increased by one unit, while,
if the first sum is strictly greater than the radix decreased by one unit (b+d>r−1), then the digits of odd rank and the digits of even rank, except the first, the penultimate and the last digits, of the corresponding modified multiplet (*,<−c,−d>^{k},*,*) are equal respectively to the opposite of the digits of even rank and to the opposite of the digits of odd rank of the elementary multiplet, the penultimate digit being determined by one of the following two sub-conditions:
if, moreover, the last sum is strictly less than the radix decreased by one unit (e+d<r−1), then the penultimate digit (d−r) of the modified multiplet (*,<−c,−d>^{k},d−r,*) is equal to the difference (d−r) between the digits of even rank (d) of the elementary multiplet (*,<d,c>^{k},d,*) and the radix (r), whereas,
if, moreover, the last sum is strictly greater than the radix decreased by one unit (e+d≧r−1), then the penultimate digit (−c) of the modified multiplet (*,<−c,−d>^{k},c,*) is equal to the opposite of the digits of odd rank (c) of the elementary multiplet (b,<d,c>^{k},d,e)

5. A method according to one of the preceding claims, in which the conversion of an elementary multiplet (b,d,<c,d>^{k},c,e) containing an even number of digits follows the following conditional steps:
if the first sum is strictly less than the radix decreased by one unit (b+d<r−1), then the digits of odd rank and the digits of even rank, except the first, the antepenultimate, the penultimate and the last digits, of the corresponding modified multiplet (*,<d,c>^{k},*,*,*)are equal respectively to the digits of odd rank and to the digits of even rank of the elementary multiplet, the last digits being determined by one of the following two sub−conditions:
if, moreover, the last sum is strictly less than the radix decreased by one unit (e+c<r−1), then the antepenultimate and the penultimate digits of the modified multiplet (*,<d,c>^{k},d,c,*) are equal respectively to the digits of even rank (d) and to the digits of odd rank (c) of the elementary multiplet(b,d,<c,d>^{k},c,e), whereas,
if, moreover, the last sum is strictly greater than the radix decreased by one unit (e+c>r−1), then the antepenultimate and the penultimate digits of the modified multiplet (*,<d,c>^{k},d+1,−d,*) are equal respectively to the value of the digits of even rank increased by one unit (d+1) and to the opposite of the digits of even rank (−d) of the elementary multiplet (b,d,<c,d>^{k},c,e), while,
if the first sum is strictly greater than the radix decreased by one unit (b+d>r−1), then the digits of odd rank and the digits of even rank, except the first, the antepenultimate, the penultimate and the last digits, of the corresponding modified multiplet (*,<−c,−d>^{k},*,*,*) are equal respectively to the opposite (−d) of the digits of even rank and to the opposite (−c) of the digits of odd rank of the elementary multiplet (b,d,<c,d>^{k},c,e), the last digits being determined by one of the following two sub-conditions:
if, moreover, the last sum is strictly less than the radix decreased by one unit (e+c<r−1), then the antepenultimate and the penultimate digits of the modified multiplet (*,<−c,−d>^{k},d−r,c,*) are equal respectively to the difference between the value of the digits of even rank and the radix (d−r) and to the value of the digits of odd rank (c) of the elementary multiplet (b,d,<c,d>^{k},c,e), whereas,
if, moreover, the last sum is strictly greater than the radix decreased by one unit (e+c>r−1), then the antepenultimate and the penultimate digits of the modified multiplet (*,<−c,−d>^{k},c,−d,*) are equal respectively to the opposite (−c) of the digits of odd rank and to the opposite (−d) of the digits of even rank of the elementary multiplet (b,d,<c,d>^{k},c,e).

6. A method according to one of the preceding claims, in which, for an elementary multiplet of type I, containing an odd number of integer digits, and written in the following form:
M1=[b,d,<c,d>^{k},e] (type I)
with k integer and b,d,c,e integers less than the radix (r) such that b+d≠r−1, c+d=r−1 and e+d≠r−1, the conversion follows one of the following conditional formulae:
$$\{ \begin{matrix}S1 = [ * , < d , c {>}^{k} , d , * ] , & if b + d < r - 1 and ⅇ + d < r - 1 , \\ S1 = [ * , < d , c {>}^{k} , d + 1 , * ] , & if b + d < r - 1 and ⅇ + d > r - 1 , \\ S1 = [ * , < - c , - d {>}^{k} , d - r , * ] & if b + d > r - 1 and ⅇ + d < r - 1 , \\ S1 = [ * , < - c , - d {>}^{k} , - d , * ] , & if b + d > r - 1 and ⅇ + d > r - 1.\end{matrix} \qquad 1 )$$

7. A method according to one of the preceding claims, in which, for an elementary multiplet of type II, containing an even number of integer digits, and written in the following form:
M2=[b,d,<c,d>^{k},c,e] (type II)
with k integer and b,d,c,e integers less than the radix (r) such that b+d≠r−1, c+d=r−1 and e+d≠r−1, the conversion follows one of the following conditional formulae:
$$\begin{matrix}\{ \begin{matrix}S2 = [ * , < d , c {>}^{k} , d , c , * ] , & if b + d < r - 1 and ⅇ + c < r - 1 , \\ S2 = [ * , < d , c {>}^{k} , d + 1 , - d , * ] , & if b + d < r - 1 and ⅇ + c > r - 1 , \\ S2 = [ * , < - c , - d {>}^{k} , d - r , c , * ] & if b + d > r - 1 and ⅇ + c < r - 1 , \\ S2 = [ * , < - c , - d {>}^{k} , - c , - d * ] , & if b + d > r - 1 and ⅇ + c > r - 1.\end{matrix} & 2 )\end{matrix}$$

8. A method according to one of the preceding claims, in which, in each modified multiplet (*,<d,c>^{k},*,*) (*,<−c,−d>^{k},*,*,*), all the digits of odd rank have the same value (c) (−d), except the first and the penultimate or the last digits, and all the digits of even rank have the same value (d) (−c), except the penultimate or the antepenultimate and the last digits.

9. A method according to one of the preceding claims, in which each modified multiplet (S^{j}) comprises a sequence of signed digits (s^{j}ᵢ,s^{j}ᵢ₋₁, . . . ,s^{j}₁) in which each pair of successive digits (sᵢ,sᵢ₋₁) has a sum with an absolute value equal to unity or to the radix decreased by one unit or to the radix (|sᵢ+sᵢ₋₁|ε{1,r−1,r}).

10. A method according to one of the preceding claims, in which the steps of converting an elementary multiplet (M^{j}) into a modified multiplet (S^{j}) are performed from the most significant digits towards the least significant digits.

11. A method according to one of the preceding claims, in which all the elementary multiplets (m^{j}ᵢ₊₁,m^{j}ᵢ,m^{j}₀) are converted into modified multiplets (*,s^{j}ᵢ, . . . ,s^{j}₁,*), and then the modified multiplets are concatenated, by chaining the sequences of signed digits of the modified multiplets one after another, omitting the unspecified first and last digits (*) of each modified multiplet (*, s^{j}ᵢ, . . . ,s^{j}₁,*).

12. A method according to one of the preceding claims, in which the elementary computation operations corresponding to each non-zero digit of each modified multiplet are performed in order to reconstruct the computation operation in terms of the numerical factor (N).

13. An electronic computation circuit, characterised in that it implements a method for breaking down and performing a computation operation according to one of the preceding claims.
